(19) United States
(12) Patent Application Publication
(10) Pub. No.: US 2021/0042975 A1
(43) Pub. Date: Feb. 11, 2021

(54) IMAGE MANIPULATION

(71) Applicant: Anthropics Technology Limited, London (GB)

(72) Inventors: Ivor James Alexander Simpson, London (GB); Sara Alexandra Gomes Vicente, London (GB); Simon Jeremy Damion Prince, London (GB)

(21) Appl. No.: 16/645,295

(22) PCT Filed: Sep. 7, 2018
(86) PCT No.: PCT/EP2018/074199

§ 371 Date: Mar. 6, 2020

(30) Foreign Application Priority Data
Sep. 8, 2017 (GB) 1714494.0

(51) Int. Cl. G06T 11/60; G06T 3/40; G06T 3/60; G06T 3/00

(52) U.S. Cl. CPC G06T 11/60; G06T 3/40; G06T 3/0093; G06T 3/0006; G06T 3/60

(57) ABSTRACT

This disclosure relates to methods of transforming an image. Disclosed herein is a method for manipulating an image using at least one image control handle. The image comprises pixels, and at least one set of constrained pixels defines a constrained region having a transformation constraint. The method comprises transforming pixels of the image based on input received from the manipulation of the at least one image control handle. The transformation constraint applies to the pixels inside the constrained region, and the degree to which the transformation constraint applies to any respective pixel outside the constrained region is conditional on the distance between the respective pixel and the constrained region.

This disclosure relates to methods of transforming an image, and in particular relates to methods of manipulating an image using at least one control handle. In more detail, methods disclosed herein are suitable for allowing the real-time, interactive nonlinear warping of images.

### BACKGROUND

Interactive image manipulation, for example for the purpose of general enhancement of images, is used in a large number of computer graphics applications, including photo editing. In some applications, the images are transformed, or warped. Warping of an image typically involves mapping certain points within the image to other, different points within the image. In some applications, the intention may be to flexibly deform some objects in an image, for example, to deform the body of a person.

However, if the effects of the transformation are smooth across the image, which is generally a desirable property, then in attempting to perform a transformation on an object in the image unwanted and unrealistic deformations of the background and/or other objects in the image may be produced. This is a particular problem when the deformed object has straight lines, which may become bent or distorted. The viewer of such a distorted and/or warped image can often discern from the bent or distorted lines that the image has undergone a transformation and/or warping process, which is undesirable in some applications.

The present disclosure seeks to provide improved methods of manipulating and/or transforming images, which allow different regions of an image to be transformed in different ways. As such, the present disclosure seeks to provide a user with a greater degree of control over the transformation of an image, including preventing or reducing the appearance of the unwanted and unrealistic deformations described above. In so doing, the present disclosure enables the manipulation of different regions of an image, while maintaining the overall smoothness of the transformations.

### SUMMARY

Aspects and features of the present invention are defined in the accompanying claims.

According to an aspect, a method for manipulating an image using at least one image control handle is provided. The image comprises pixels, and at least one set of constrained pixels defines a constrained region having a transformation constraint. The method comprises transforming pixels of the image based on input received from the manipulation of the at least one image control handle. The transformation constraint applies to the pixels inside the constrained region, and the degree to which the transformation constraint applies to any respective pixel outside the constrained region is conditional on the distance between the respective pixel and the constrained region.

Optionally, the degree to which the transformation constraint applies to any respective pixel outside the constrained region is conditional on the relative distances between the respective pixel and the constrained region, and between the respective pixel and the original location of the at least one image control handle.

This method provides for smooth transformations, and allows the warping of an image in a manner that reduces the appearance of unrealistic and unwanted distortions.

Optionally, the input comprises information relating to the displacement of the at least one image control handle from an original location in the image to a displaced location in the image.

For example, the user may define a desired warp of the image by moving the control handles. The control handles may be control points, which are points in the image. The displacement of the control handles may comprise a mapping between the original location of the control handle and the displaced location of the control handle.

Optionally, each pixel transformation is weighted by the distance from each respective pixel to an original location of the at least one image control handle such that pixels located nearer the original location of the image control handle are more influenced by the displacement of the at least one image control handle than those further away.

Optionally, the degree to which the constrained transformation applies to pixels outside the constrained region approaches zero for pixels at the original location of the at least one control handle.

Optionally, transforming each pixel based on the input comprises determining a first set of pixel transformations for the pixels outside the constrained region, each pixel transformation of the first set of pixel transformations being based on the displacement of the at least one image control handle, and determining a second set of pixel transformations for pixels inside the constrained region, each pixel transformation of the second set of pixel transformations being based on the displacement of the at least one image control handle and the transformation constraint. Each pixel transformation of the second set of pixel transformations may be based on the displacement of the at least one image control handle and the transformation constraint properties.

Optionally, the method may further comprise applying the second set of transformations to the pixels inside the constrained region, and applying a respective blended transformation to pixels outside the constrained region, wherein the blended transformation for a particular pixel outside the constrained region is a blend between the first and second transformation, and the degree to which the pixel follows the first transformation and/or the second transformation is determined by the relative distances between the respective pixel and the constrained region and the respective pixel and the original location of the at least one control handle. The degree to which the pixel follows the first transformation and/or the second transformation may be determined by the relative distances between the respective pixel and the constrained region and the respective pixel and the original location of the at least one control handle.

The degree to which the pixel follows the first transformation and the second transformation may be determined by a blending factor. The blending factor at a particular pixel depends on the location of the pixel with respect to the constrained region and the at least one control handle. For example, pixels located nearer to the constrained region than to the original location of the at least one control handle follow the constrained transformation more strongly than those pixels located further away from the constrained region.

Optionally, the first and second sets of transformations are determined by minimising a moving least squares function.

Optionally, the image further comprises a plurality of constrained regions, each constrained region defined by a respective set of constrained pixels, and each constrained region having a respective transformation constraint associated therewith. The degree to which a particular transformation constraint applies to each pixel outside the constrained regions is based on the distance between a respective pixel and the constrained region associated with the particular transformation constraint. The degree to which a particular transformation constraint applies to each pixel outside the constrained regions may be based on the relative distance between a respective pixel and the constrained region associated with the particular transformation constraint and the distance between a respective pixel and all other constrained regions and the at least one control point.

Optionally, the constrained regions are not spatially contiguous.

Optionally, each constrained region is associated with a different transformation constraint.

Optionally, the distance between the respective pixel and the constrained region is a distance between the pixel and a border of the constrained region.

Optionally, the at least one image control handle is a plurality of image control handles and the input comprises information about the displacement of each of the plurality of image control handles; and the method comprises transforming each pixel based on the displacement of each of the plurality of image control handles.

Optionally, the degree to which the transformation of a particular pixel is influenced by the displacement of a particular image control handle is based on a weighting factor, the weighting factor being based on the distance from the particular pixel to an original location of the particular image control handle.

Optionally, the plurality of image control handles comprises a number of displaceable image control handles and a number of virtual image control handles which are not displaceable, the virtual image control handles being located around a border of the constrained region, and wherein the virtual image control handles are for lessening the influence of the displaceable image control points on the transformation of the constrained pixels. The method may further comprise weighting the transformation of each respective pixel outside the constrained region based on the distance from each respective pixel outside the constrained area to each respective displaceable image control handle; and weighting the transformation of each respective constrained pixel inside the constrained region based on distances from each respective constrained pixel to each of the plurality of image control handles, including the displaceable image control handles and the virtual image control handles.

Optionally, the at least one image control handle is any of the following: a point inside or outside the image domain or a line in the image.

In examples in which a mesh is used, mesh points are located in a regular fashion throughout the image. Additional mesh points are located at every control point's original position, add additional mesh points can be placed by tracing around the outside of constrained regions and simplifying any straight lines, adding these segments to the mesh.

Optionally, the constrained region and/or the transformation constraint is selected by a user.

Optionally, the transformation constraint is one of, or a combination of: a constraint that the pixels within the constrained region must move coherently under a translation transformation; a constraint that the pixels within the constrained region must move coherently under a rotation transformation; a constraint that the pixels within the constrained region must move coherently under a stretch and/or skew transformation; a constraint that the relative locations of the pixels within the constrained region must be fixed with respect to one another.

Optionally, the transformation constraint comprises a directional constraint such that the pixels in the constrained region may only be translated or stretched, positively or negatively, along a particular direction.

Optionally, those pixels located around the border of the image are additionally constrained such that they only be translated or stretched along the border of the image or transformed outside the image domain.

Optionally, the influence of a particular transformation constraint upon an unconstrained pixel can be modified through a predetermined, for example a user determined, factor.

Optionally, the degree to which the transformation constraint applies to any respective pixel outside the constrained region is conditional on the relative distances between the respective pixel and the constrained region, and between the respective pixel and the original location of the at least one image control handle.

Optionally, the transformation of the pixels in the constrained region takes the form of a predetermined type of transformation. For example, the transformation of the pixels in the constrained region may takes the form of a predetermined parametrisation.

Optionally, the type of transformation is one of, or a combination of: a stretch, a rotation, a translation, an affine transformation, and a similarity transformation.

Optionally, the method may further comprise determining, for each pixel in the constrained region, a constrained region pixel transformation based on the manipulation of the at least one control handle and the transformation constraint, and determining, for each pixel outside the constrained region, both a constrained transformation and an unconstrained transformation, the constrained transformation being based on the manipulation of the at least one control handle and the transformation constraint, and the unconstrained transformation being based on the manipulation of the at least one image control handle and not based on the transformation constraint.

Optionally, the method may further comprise transforming the pixels in the constrained region based on the constrained region pixel transformations determined for the constrained pixels; and transforming the pixels outside the constrained region based on a blended transformation, the blended transformation for a particular pixel outside the constrained region being based on the constrained transformation and the unconstrained transformation determined for the particular pixel, wherein the degree to which the blended transformation follows either the constrained or the unconstrained transformation at that particular pixel is determined by a blending factor based on the relative distance between the particular pixel and the original location of the at least one image control handle, and the relative distance between the particular pixel and the constrained region.

The blending factor may operate on the blended transformation at a pixel such that those pixels nearer the constrained region are more influenced by the constrained transformation determined at that pixel than the unconstrained transformation at that pixel, and such that those pixels near the original location of the at least one image control handle are more influenced by the unconstrained transformation determined at that pixel than the constrained transformation at that pixel. In other words, the blending factor ensures a smooth blend of transformations is performed across the image.

According to an aspect, a computer readable medium comprising computer-executable instructions which, when executed by a processor, cause the processor to perform the method of any preceding claim.

### FIGURES Specific embodiments are now described, by way of example only, with reference to the drawings, in which:

FIG. 1a depicts an example of an input image, and FIGS. 1b and 1c depict transformed images in which the image transformation has been performed using a prior art method.

FIG. 2a depicts the example input image of figure la as seen in an editing view of software which allows the manipulation of images according to methods of the present disclosure; FIGS. 2b and 2c depict transformed images in which the image transformation has been performed using methods of the present disclosure.

FIGS. 3a)-d) schematically compare a warp of an original image using a prior art technique and the presently disclosed techniques.

FIG. 4 is a schematic representation of different constraints applied to different constrained regions.

FIG. 5 is a schematic illustration of calculating a final transformation at a particular point in the image;

FIG. 6 is a schematic illustration showing different methods for calculating the weight of a point with respect to a constrained region.

FIG. 7 is a schematic illustration showing the calculation of the weight of a point with respect to a line segment along the border of a constrained region.

### DETAILED DESCRIPTION

The present disclosure seeks to provide a method of warping an image, in which a user can warp a particular object or region of the image while minimising unrealistic warping of other regions of the image. In an example, and as depicted in the figures of the disclosure, the method can be used to make a person appear larger or smaller, without warping the background objects or the borders of the image in an unrealistic manner. To do this, a user may select a region of the image to which a transformation constraint will apply. In a simple example, the transformation constraint may be that pixels within the constrained region may only move left and right (i.e. along a horizontal axis with respect to the image). Such a transformation constraint may be useful when, for example, the user wishes to warp an object of interest which is placed in close vicinity to a background object having horizontal lines, such as blinds or a table top.

Using the example above, the user would select the region of the image containing the blinds or table top as a constrained region. Once a constrained region has been chosen, a user may manipulate, warp and/or transform the image. For example, the user may wish to stretch a portion of the image, e.g. to make an object in the image wider. To effect this stretch, the user may, for example, use an image control handle to pull or stretch the object of interest. The transformation at a particular pixel depends on the location of the pixel. Pixels inside the constrained region adhere to the transformation constraint, i.e. in the example given above, pixels inside the constrained region are transformed based on the manipulation of the control handles, while adhering to the constraint that they can only locally move along a horizontal axis relative to the image. The transformation of a pixel outside the constrained region depends on the distance between the particular pixel and the constrained region. In more detail, the transformation of a pixel outside the constrained region may depend on the relative distance between the particular pixel and the constrained region and the particular pixel and each of the set of control handles. In other words, the transformation constraint applies to varying degrees to those pixels outside the constrained region. In still other words, pixels outside but very close to the constrained region are almost entirely constrained to move only left and right, but may move in other directions slightly. Pixels outside and far away from the constrained region are hardly constrained at all by the transformation constraint. In this way, a blending between the user's inputted transformation, i.e. the stretch, and the restrictions imposed by the transformation constraint, i.e. the constraint to only move left and right, is applied for pixels outside the constrained region. This functionality means that a user can effectively and realistically warp particular regions of the image, while ensuring that any repercussive transformations, e.g. in regions of the image which contain background objects, are realistic and smooth.

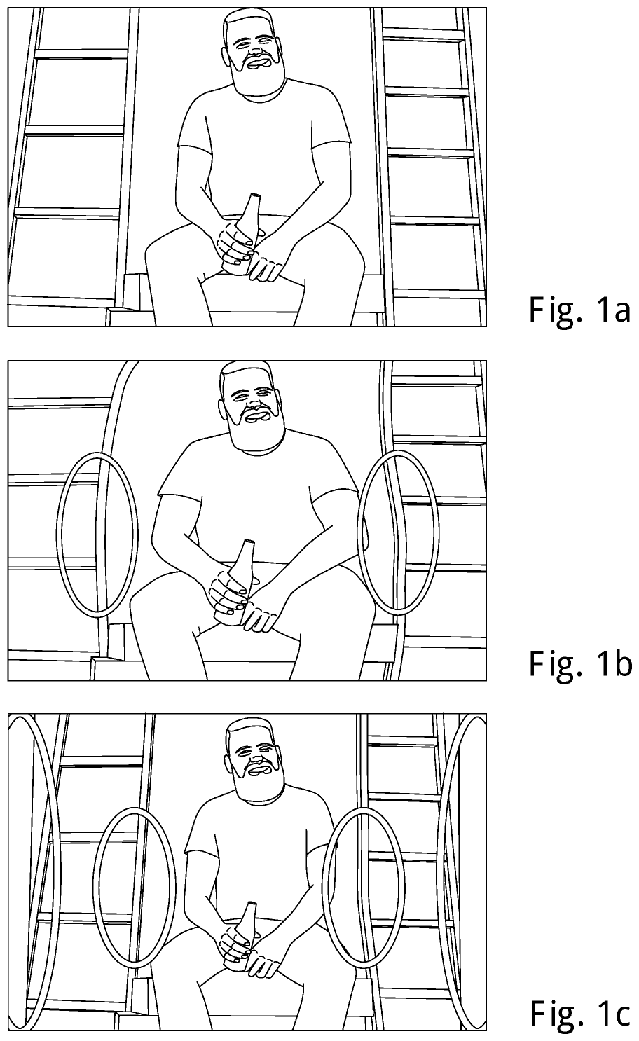

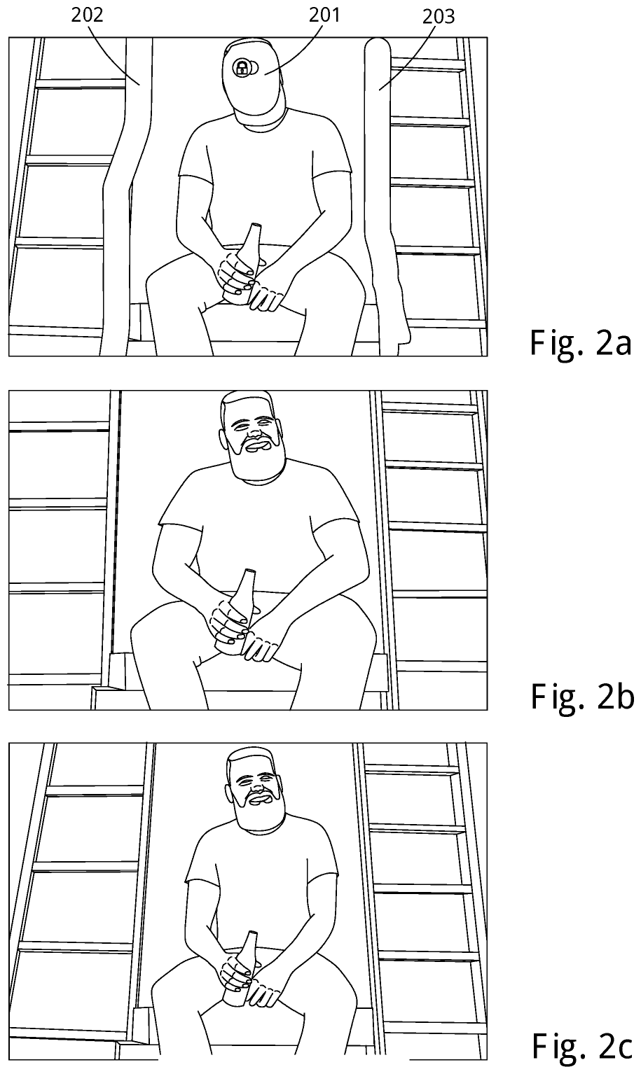

FIG. 1a shows an original photograph, which has not undergone any manipulation. This may be described as an input image. FIGS. 1b and 1c depict the warping of an image according to a prior art method, and FIGS. 2b and 2c show a corresponding warping of the image using a method of the present disclosure. It will be appreciated that FIGS. 1b and 1c, which have been warped using a prior method, show unrealistically distorted photographs.

FIG. 1a shows an original photograph/image of a man standing in front of two ladders. The region of the image which contains each ladder comprises straight lines, those lines being roughly vertical and horizontal. A user wishes to make the man in the image appear larger. In the unrealistically distorted photograph shown in FIG. 1b, the straight lines of the ladder have been warped in the region adjacent to the man's arm. The straight lines are now bowed outwards. Also, the man's face has been horizontally stretched in an unrealistic manner. It will be appreciated that a viewer of this distorted image will be able to recognise that the image has undergone a manipulation process and has been distorted. This unrealistic warping of the image may not be the user's intention, and it may instead be desirable that a viewer of the manipulated image does not realise that the image has undergone a manipulation process.

Similarly, FIG. 1c shows the resulting warped image where a user has instead attempted to make the man appear smaller using a prior art technique. The vertical lines of the ladder have bowed inwards, and the edges of the image have been pulled inwards to accommodate the user's intended image warp. Again, the resulting image shows a distorted image, which a viewer would immediately recognise as having been distorted using an image manipulation process.

In the realistically distorted photograph/images shown in FIG. 2, prior to warping the image, the regions of the image which comprise the vertical ladder portions were defined by the user as constrained regions of the image, according to methods described in further detail below. The region of the image which contains the man's face was also defined as a constrained region. These constrained regions of the image are shown in FIG. 2a. The borders of the image are also defined as a constrained region (not shown). In FIG. 2c, the image has been manipulated in a manner that makes the man look larger, and n FIG. 2c the image has been manipulated in a manner that makes the man look smaller, or thinner. As a result of the methods disclosed below, the vertical lines of the ladder in the distorted images of FIGS. 2b and 2c has retained its vertical shape. The man's face has not been unrealistically stretched or skewed. The borders of the image have not been pulled inside the domain of the image. Thus, it is difficult to discern that the image has been distorted or manipulated.

FIG. 2a depicts the original image of figure la as might be viewed in image editing software. In other words, FIG. 2a shows an editing view. The software is programmed to perform the image manipulation methods described herein. When displayed on a screen, the image is represented as a two-dimensional array of pixels. The images may each be represented and stored in terms of the red, green, and blue (RGB) components of each pixel in the array. In this manner, the image is made up of, and hence comprises, pixels. A location of a particular pixel in the image can be defined in terms of an x and a y co-ordinate in a Cartesian co-ordinate system.

In the editing view, a user can define a constrained region, which is made up of a set of pixels of the image. The pixels which are within the constrained region are constrained, as will be discussed in further detail below. Accordingly, the constrained region is defined by a set of constrained pixels. The user can outline the region of the image to be constrained using a selection tool within the image editing software. For example, the user can define the boundaries of the constrained region by clicking and drawing with their cursor using a mouse, or, for example, by dragging their finger on a touch-sensitive input device to define a boundary of the constrained region.

The constrained regions undergo constrained transformations, as will be described in greater detail below. A plurality of sets of constrained pixels, i.e. a plurality of constrained regions, can be defined, where a pixel belongs to one constrained region and the constrained regions do not need to be spatially contiguous. In FIG. 2a, a region of the image which contains the man's face is defined as a first constrained region, a region of the image which contains the left ladders' inner vertical edge is defined as a second constrained region, and a region of the image which contains the right ladder's vertical edge is defined as a third constrained region. The border of the image is defined as a fourth constrained region (not shown).

In the editing view, the constrained regions may comprise constrained region icons. For example, a first constrained region icon is located within the first constrained region. The first constrained region icon indicates to the user that the first constrained region is constrained, and also denotes the type of constraint. In this case, the first constrained icon shows a lock, indicating that the type of constraint is a “fixed” constraint, in which the pixels of the first constrained region may not be moved or transformed.

In this case, the pixels in the first constrained region, 201, i.e. the region associated with the man's face, are constrained by a similarity constraint. This means that the constrained pixels can only be transformed by a similarity transformation. In other words, these pixels can only be stretched, skewed, rotated, or moved in a way in which the overall shape of the man's face is retained, i.e. which results in a conformal mapping between the original pixel locations and the final pixel locations. For example, the man's face can be rotated, translated, enlarged, or made smaller. However, the man's face cannot be stretched or skewed in a particular direction. This type of constraint is particularly useful for constraining regions of the image which contain faces, as viewers of distorted images are particularly good at noticing stretches and skews in such regions. In some examples, facial detection software can be used to identify/detect faces in the image and automatically mark the detected image regions as similarity-constrained regions.

The pixels of the second (202) and third (203) constrained regions, i.e. the regions of the image containing the vertical edges of the ladders, are allowed to locally move in the direction of the vertical edge of the ladder and also coherently stretch in the perpendicular direction. In other words, these pixels may only slide up and down in the direction of their ladder's vertical edge as well as coherently stretch in the perpendicular direction. The pixels in these constrained regions (202, 203) cannot locally slide, for example, in a horizontal direction. This type of constraint is particularly useful for regions of the image which contain straight lines. By constraining pixels to only locally move in the direction of the straight lines, you minimise the effects of a transformation or warp which would otherwise act to bend or curve the straight lines, whilst allowing some flexibility for pixels along the line to deform and hence the resulting warped image is more realistic. Allowing pixels to coherently stretch in the perpendicular direction may also allow more plausible stretching effects of background objects, i.e. the vertical edges of the ladder can appear to be consistently wider or narrower depending on the manipulation of the control handles.

The pixels of the fourth constrained region, i.e. the region associated with the borders of the image, are constrained such that they can only locally slide along the edges of the border, as well as move outside the image domain. However, under this transformation constraint, the pixels at the borders cannot move inside the image domain. This type of constraint prevents unrealistic warping at the edges of an image, as shown in FIG. 1c. Again, pixels at or adjacent to the image borders may be automatically identified and marked as a constrained region by the editing software.

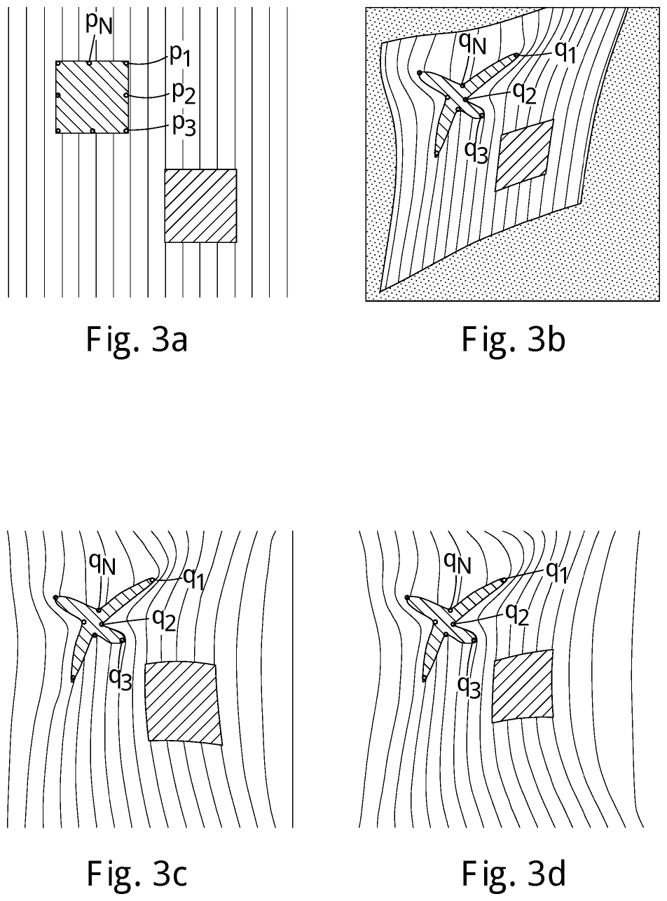

With reference to FIGS. 3a-d, once the user has selected the constrained regions of the image, the image can be warped, or otherwise manipulated, using image control handles. The image control handles can be manipulated by a user in order to manipulate the image. The manipulation of the control handles can be used to define a nonlinear transformation of any location within, or outside the image domain. The image control handles may be, for example, a line in the image. In a preferred embodiment, control points as shown in FIG. 3a-d are used as image control handles. These control points can be defined at arbitrary locations within, or outside the image domain. The displacement of these control points is used to define the image manipulation desired by the user.

FIG. 3a shows a schematic representation of an original, i.e. not warped, image. The image contains two object of interest: a blue square located toward the upper left corner of the image, and a yellow square located toward the bottom right of the image. Eight control points are placed on the edge of the blue square. The original locations of the control points are labelled p₁ to p₈. To warp the image, the user displaces the control points to define a non-linear transformation. The user can manipulate, e.g. displace, the image control handles to define a desired warping of the image. For example, the user may move an image control handle from an original image control handle location to a displaced image control handle location. The displacement of the control handles can be described as an instruction to warp the image, the instruction comprising information about the displacement of the control handles.

For example, FIG. 3b shows the resulting warped image following a displacement of each of the control points. The displaced locations of the control points are labelled q1 to q8. In this example, the user's region of interest is the blue square. However, it will be appreciated that warping the blue square results in substantial changes to the shape of the yellow square and pulls in the borders of the image. These repercussive warps may not have been intended by the user. FIG. 3c shows the resulting warp following the same displacement of the image control points, but where a border constraint in accordance with the present disclosure is added. The border constraint in FIG. 3c has a border constraint with a strong effect on unconstrained pixels. As will be described later, the border constraint in FIG. 3c has a smaller value for a, leading to a larger weight for the border transformation in pixels that are not on the border. This leads to a smooth result at the edges of the image. FIG. 3d shows the same result with a weaker border constraint effect on unconstrained pixels. As will be described later, the border constraints shown in FIG. 3d have a larger value for a. As will be described later, a is a tunable parameter that controls the strength of the constraint on unconstrained pixels.

Methods of the present disclosure are now described in further detail.

The original locations of the image control points can be represented using a vector P as follows:

P=(p₁, p₂, . . . p_{I})

where I labels the control points such that p₁ is the original vector location of a first control point, p₂ is the original vector location of a second control point, and so on. The final locations of the control points, i.e. the locations of the control points after they have been displaced, can be represented using a vector Q as follows:

Q=(q₁, q₂, . . . q_{I})

where q₁ is the displaced vector location of the first image control point, q₂ is the displaced vector location of the second image control point, and so on.

Upon receipt of information about the displacement of the image control handles, pixels of the image are transformed and/or warped based on the displacement of the image control handles. The pixels which are located near the original, undisplaced locations of the image control handles/points are affected more than those pixels which are located further away from the original position of the image control handles. In other words, each pixel transformation is weighted according to the distance from the pixel to the original position of the control handle, such that pixels located nearer the original position of an image control handle are more influenced by the displacement of the image control handle than those pixels which are further away from the original position of the control handle. The particular transformations of each pixel can be determined by minimising a moving least squares function, as will be described below.

Generally, the nonlinear transformation defined by the displacement of the control points is locally parameterised as a linear transformation, F(x), which varies based on a vector location, x, within the image.

A constrained transformation, can be estimated at any constrained pixel location, vErⱼ, where rⱼ is the j-th set of constrained pixels. In other words, j is used to label each of the constrained regions of the image. The constrained transformation has a defined parameterisation that may differ from that used for the linear transformation. Furthermore, for specified pixel sets a single linear transform can be estimated, which leads to sets of pixels that move coherently.

Constrained pixel sets can have a linear transformation constraint and/or a non-linear transformation constraint. In linearly constrained regions, the constrained pixels move coherently together. A constrained pixel set which is linearly constrained follows a constant linear transformation at the points within the boundary of its constrained region. Pixels may alternatively have a non-linear transformation constraint.

In some embodiments, pixels of the image other than those in a constrained region may also be constrained. A special case of constrained pixels are those at the borders of the image. These are constrained to follow a nonlinear transformation, whereby they cannot move inside the image, but may slide along the border, or move outside the visible set of pixels.

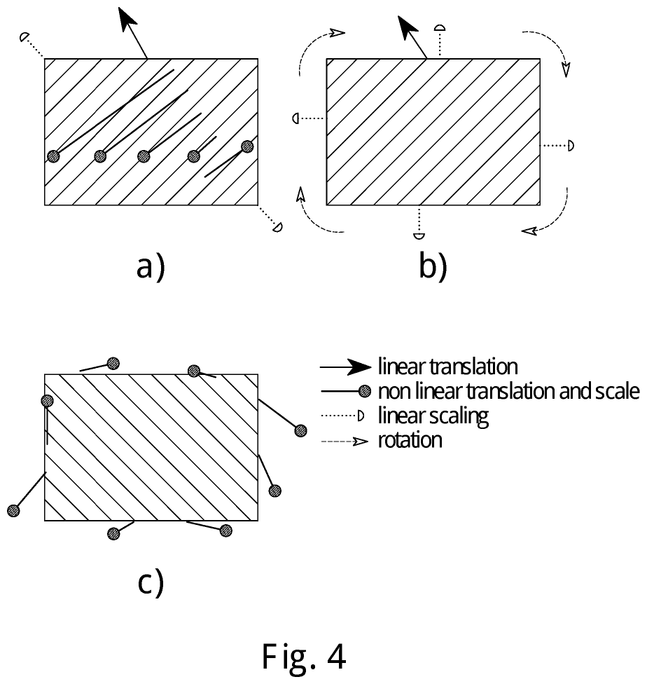

FIG. 4 depicts regions constrained by different transformation constraints. FIG. 4a shows a non-linearly constrained region, where the region can linearly translate and scale in one direction. Pixels within the constrained region can linearly scale, but local translations are constrained to be along a given vector perpendicular to the directional scaling.

FIG. 4b depicts a linearly constrained region that follows a similarity parameterisation. As will be known by the skilled person, a similarity transformation is a transformation in which the relative size of an element within the constrained region is maintained with respect to other elements within the constrained region. Thus, the constrained region depicted in FIG. 4b can be linearly scaled larger or smaller, and can be rotated.

FIG. 4c Illustrates the border constraint, where pixels on the border can slide along the border or move outside, but not inside.

### Estimating the Transformation at a Point/At a Respective Pixel

### Estimating Unconstrained Transformation

The transformation of a pixel outside each of the constrained regions, at a pixel location, x, is given by the moving least squares estimator. The moving least squares technique used the displacement of the control points from positions pᵢ to positions qᵢ to define a linear transformation at any point in the image domain. In other words, the moving least squares technique can be used to determine the transformation of a particular pixel following the manipulation/displacement of the image control points.

For a given position x, the optimal local transformation F(x) is given by finding the transformation which minimises the moving least squares cost function:

Σᵢ^{I}wᵢ |F(pᵢ)−qᵢ|² (1)

where wᵢ=W(x, pᵢ) is a weighting factor that depends on the distance between a pixel at location x and the original location of the ith image control point, pᵢ. F(x) is a linear transformation at x, p is a vector of the original control point locations and q is the vector of the displaced control point locations. Thus, the optimisation of F(x) can be efficiently achieved through solving this weighted least squares problem.

In a preferred embodiment, wᵢ is calculated as an inverse distance measure between pᵢ and x, such that pixels located nearer the original location of the ith image control point are influenced by the displacement of the ith image control point to a greater degree than those further away. For a given pixel, x, wᵢ thus takes the form:

$${w}_{i} = \frac{1}{D ( x , {p}_{i} )}$$

where D is a distance metric of x from pᵢ. In other words, D describes the distance in the image between a particular pixel located at x and the original location of a particular image control point, pᵢ. wᵢ may take the following form:

$${w}_{i} = W ( x , {p}_{i} ) = \frac{1}{{\vert {p}_{i} - x \vert}^{2 α}} \qquad ( 2 )$$

where α is a tuning parameter for the locality of the transformation. In a simple example, α may simply equal 1.

By parameterising the non-linear transformation defined by the displacement of the control points as a linear transformation F(x)=xΣ+β, where Σ is a linear matrix and β is a translation, it is possible to efficiently calculate a least squares solution to estimate these parameters.

The translation component, β, can be solved for by differentiating the moving least squares cost function with respect to β. By doing so it can be shown that:

$$β = {q}_{*} - {p}_{*} Σ \\ where \text{:} \\ {p}_{*} = \frac{{Σ}_{i} {w}_{i} {p}_{i}}{{Σ}_{i} {w}_{i}} and {q}_{*} = \frac{{Σ}_{i} {w}_{i} {q}_{i}}{{Σ}_{i} {w}_{i}} . \qquad ( 3 )$$

It is therefore possible to write the moving least squares cost function as follows:

$${\sum }_{i} {w}_{i} {\vert {p}_{i} Σ + {q}_{*} - {p}_{*} Σ - {q}_{i} \vert}^{2} \\ {\sum }_{i} {w}_{i} {\vert \hat{{p}_{i}} Σ - \hat{{q}_{i}} \vert}^{2} \qquad ( 4 )$$

where \hat{p}ₗ =pᵢ−p_{*} and \hat{q}ₗ=qᵢ−q_{*}.

The estimation of Σ can now be seen as a weighted multiple linear regression problem, in which targets \hat{q}ᵢₓ and \hat{q}_{iy} must be predicted given \hat{p}ᵢₓ and \hat{p}_{iy} multiplied by the columns of matrix Σ. The weighted linear least squares solution for Σ is:

$${Σ}_{ls} = {( {\sum }_{i} {w}_{i} {\hat{p}}_{i}^{T} {\hat{p}}_{i} )}^{- 1} {\sum }_{j} {w}_{j} {\hat{p}}_{j}^{T} {\hat{q}}_{j} \qquad ( 5 )$$

In this formulation, as will be appreciated by the skilled person, parts of this equation can be precomputed/precalculated for fixed P. This hugely increases the computation speed when the image control points are moved by a user in order to warp the image, allowing the warping of images to occur in real time as the user displaces the image control points. Thus, the image warping process can be more interactive and user-friendly.

### Estimating Constrained Transformations

When finding the transformation of a constrained pixel, i.e. a pixel in a constrained region, additional constraints are placed on F(x).

In a constrained region, the constrained pixels may be constrained to move according to a single linear transformation, or may be constrained according to a different parameterisation, e.g. where stretching and scaling are only allowed in one direction. The pixels on the border of the image, whether part of a constrained region or not, may be additionally constrained to only move along the image border or outside the image, i.e. they can be constrained such that they are forbidden from moving inside the image. Each of these constraints is considered in turn below.

In an image with ‘j’ constrained regions, it is useful to define R=(r₁, r₂ . . . rⱼ), where R is a vector describing the locations of the constrained regions and r₁ labels the first constrained region, r₂ labels the second constrained region, and so on.

### Linear Constraint Region

A linear constraint region is one that is defined to follow a constant linear transformation at all points within its boundary. Similar to the unconstrained transformations, a weighted least squares formulation is used to find the optimal parameters for the chosen linear transformation constraint/transformation parameterisation.

To determine the transformation of a pixel and/or at a point in a constrained region, the optimisation is performed as a weighted least square estimation of the given transformation parameterisation, where for a given constrained region, rⱼ, the weight of control point i, wᵢ, is given by the weighting function between a point and a region, W_{c}, wᵢ=W_{c}(pⱼ, rᵢ).

The constrained region weighting function W_{c} is similar to the weighting factor W used for determining the weighting between a pixel and a control point for non-constrained pixels, however W0 depends on the inverse distance between a constrained pixel region at location rⱼ and the original location of the ith image control point, pᵢ.

Using the standard moving least squares function, the optimal transformation is calculated for a pixel at a particular point. However, constrained regions are not points, and thus in some embodiments a different formulation for calculating the weight function between control points and regions may be used. In a simple example, it is possible to calculate the optimal transformation for a point at the centre of the region, and use this transformation for the entire region, i.e., the region is treated as though it were a point.

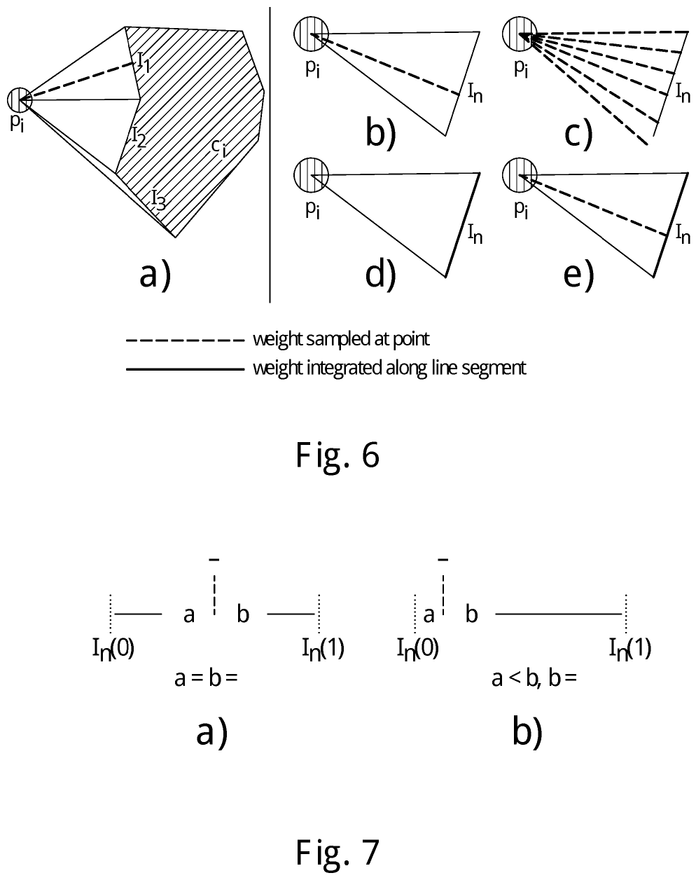

FIG. 6 shows different methods for calculating the weight of a point with respect to a constrained region.

FIG. 6a Illustrates the simplest approach of simply sampling the weight of the closest point on the boundary of the constrained region,

$${W}_{c} ( {p}_{i} , {r}_{j} ) = max \frac{1}{D ( {p}_{i} , φ ( {p}_{i} {l}_{n} ) )} ,$$

where Iₙ is a line segment of the traced constraint border and ϕ(pᵢlₙ) is the projection of pᵢ onto Iₙ.

FIG. 6b shows sampling the closest points on each segment,

$${W}_{l} ( {p}_{i} , {l}_{n} ) = \frac{1}{D ( {p}_{i} , φ ( {p}_{i} {l}_{n} ) )} \frac{1}{σ} . σ$$

is an adjustable overall constraint factor, akin to a weight sampling distance along the border. The manipulation of a allows the influence of a particular transformation constraint upon an unconstrained pixel to be modified through a predetermined, for example a user determined, factor.

FIG. 6c shows sampling at regular intervals along all the borders of the constraint.

FIG. 6d illustrates integrating the weight over each line segment,

$${W}_{l} ( {p}_{i} , {l}_{n} ) = {\int }_{0}^{1} \frac{1}{D ( {p}_{i} , φ ( {p}_{i} {l}_{n} ) )} d δ \frac{1}{σ}$$

FIG. 6e illustrates a preferred method, where for every line segment the weight of the nearest point is sampled and the weight of the rest of the line is integrated over. FIG. 7 is a schematic illustration showing the calculation of the weight of a point with respect to a line segment along the border of a constrained region. FIG. 7 shows in more detail the sections of the line to be integrated over with respect to the nearest point and a. Further detail on this method, and how to calculate the weight from points to constrained regions generally, is given in the below section titled “Calculating the weight between points and constrained regions”.

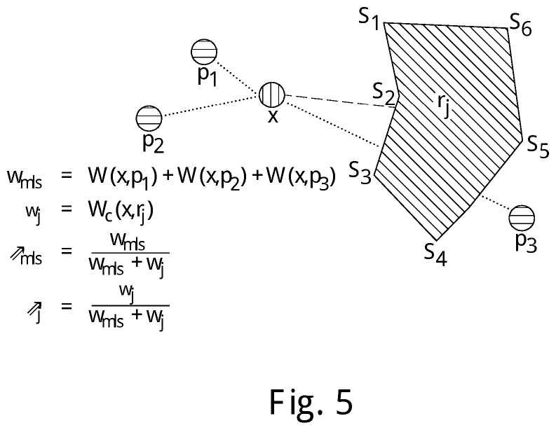

FIG. 5 shows a schematic illustration of calculating a blending factor at point x for use when blending the constrained and unconstrained transformations. FIG. 5 shows three controls points with original locations P=(p₁; p₂; p₃) and a constrained region rⱼ. The constrained region has boundary vertices denoted by S₁-S₆.

The unconstrained transformation at x is estimated using equations 5 and 3, as discussed above. In this example, control point p₁ will have the largest influence on the estimated unconstrained transformation as it is the nearest control point. Similarly, a first set of pixel transformations may be determined for each pixel outside the constrained region. Each pixel transformation of the first set of pixel transformations is based on the displacement of the at least one image control handle, and is weighted by the distance of the particular pixel from the original locations of the image control points.

In the case that the estimated constrained region transformation for region rⱼ is a linear transformation, the constrained transformation for pixels inside the region is estimated based on the displacement of the image control points where the weights of each control point on the region transformation is determined by W_{c}. In this way, a second set of pixel transformations may be determined for pixels inside the constrained region. Each pixel transformation of the second set of pixel transformations is based on the displacement of the at least one image control handle and the transformation constraint.

The final transformation at x is a linear blending of the constrained transformation of rⱼ and the unconstrained transformation. The blending factor is based on the distance between the pixel at x and the constrained region. For example, the blending factor may be determined by the relative distance-based sum of control points weights calculated by W and W_{c}(x; rⱼ)

As weighting values W and W_{c} are both inverse distance measures, it will be appreciated that their value tends toward infinity as the respective distance metrics approach zero. Therefore, to ensure smooth and stable transformation determination, a maximum value of W and of W_{c} is assigned. This maximum weighting value can be presented as Wₘₐₓ, and in a preferred embodiment is the same maximum value for both W and W_{c} such that:

[symbol]

_{c}(pⱼ, rᵢ)= [symbol] (pⱼ, pⱼ)wₘₐₓ> [symbol] _{c}(pⱼ, rᵢ), ∀pⱼ ∈ rᵢ, pₖ ∉ rᵢ (6)

Similarly, the normalised weighting factor for a constrained transformation region may be zero for pixels that are far from rⱼ but close to pᵢ, or vice versa.

### Non-Linear Constraint Regions

In some situations, there may be a need to change the linear parameterisation of F(x) to preserve certain features of the image. For instance, perhaps in some areas of the image, there are parallel lines. An example of this can be seen in FIGS. 1a-c and 2-c in which the edge of a ladder comprises a straight line. In order to make an image warp more realistic, a suitable constraint for such a region would be that the region can freely deform in a direction parallel to the edge of the ladder, i.e. roughly up and down in the image seen in FIGS. 1a-c and 2-c. It will be appreciated that localised deformation perpendicular to the line of the ladder's edge, i.e. left and right in FIGS. 1a-c and 2a-c, would result in a warp that is not realistic. Furthermore, all the pixels within a non-linear constraint region can also share a common linear transformation, for example allowing a coherent stretch in the direction perpendicular to the local stretch.

The above described constraint can be achieved by modifying the locally estimated linear transformation parameterisation such that only stretches and translations in a single direction are allowable. The estimator for F(x) is again a moving least squares cost function, where the weights are given by:

$$W ( x , {p}_{i} ) = \frac{1}{{\vert {p}_{i} - x \vert}^{2 α}}$$

as above. Further detail on the derivation of a weighted least squares estimation for a directional stretch are given in the section below titled “Derivation of a single direction stretch estimator”.

### Border Constraints

For those pixels at or adjacent to the border of the image, the moving least squares cost function analysis is modified as set out below.

For inference of the transformation at the borders of the image, we wish to find a transformation that does not require image extrapolation, i.e. the edges of the image are not pulled in. The optimal transformation F(x)=xΣ+β for pixels and/or points on the border of the image, these points and/or pixels being labelled m, can be found by minimising the moving least squares cost function:

Fₘ(m)=Σᵢ^{I}wᵢ|pᵢΣ+β−qᵢ|² (7)

where Σ is a 2×2 matrix and pᵢ, β and qᵢ are row vectors of length 2.

For a given point on the left boundary of the image, the minimisation is subject to the constraint Fₘ(m)≤0, as follows:

$$[ {m}_{x} {m}_{y} ] [ \begin{matrix}{Σ}_{11} \\ {Σ}_{21}\end{matrix} ] + {β}_{x} <= 0 \\ {m}_{x} {Σ}_{11} + {m}_{y} {Σ}_{21} + {β}_{x} <= 0 \qquad ( 8 )$$

Further clarification on the maths applicable at the border of the image can be found in the section below entitled “Border constraints”.

### Inertia

In some situations, particularly for border constraints, encouraging a constrained region to not move too much may provide a more plausible warping than estimating the transformation purely from the control points. This may have the effect of making some regions stretch rather than translate, and allows smoother warping at the edges of the image.

An inertia regularisation factor is introduced, which introduces an additional term in the transformation optimisation, minimising the movement of the constraint border—some points of which are likely to not be moving.

F=Σᵢ^{I}wᵢ|pᵢΣ+β−qᵢ|²+τΣⱼ^{J}ϕⱼ|mⱼΣ+β−mⱼ|² (15)

In other words, for a particular constrained region it is possible to add an ‘inertia factor’ which discourages pixels within the constrained region from moving from their original locations.

Further detail is given below in the section entitled “Inertia Regularisation”.

### Transformation Smoothness

Constrained regions need to be properly accounted for to ensure that the transformations vary in a spatially smooth fashion.

A blending between the transformation defined by the displacement of the image control handles and the restrictions imposed by the transformation constraint is achieved for pixels outside the constrained region. This functionality means that a user can effectively and realistically warp particular regions of the image, while ensuring that any repercussive transformations, e.g. in regions of the image which contain background objects, are realistic and smooth.

Smoothness of the estimated transformation, obtained via the moving least squares function, between constrained and unconstrained regions can be enforced by linear blending of the transformations at these locations together.

Linear blending of affine transformations can be efficiently computed by transforming the affine matricies to the logarithmic space, where a simple weighted sum of the matrix components can be performed, followed by an exponentiation:

$${Σ}_{x} = exp ( {\hat{w}}_{mls} log {Σ}_{mls} + {\sum }_{k}^{K} {\hat{w}}_{k} log {Σ}_{k} ) \qquad ( 18 )$$

where wₘₗₛ=Σᵢ^{I}wᵢ, where I sums over control points and w_{c}=Σₖ^{K}wₖ, where k sums over constrained regions and wᵢ and wₖ are calculated as the distance from the control point/region respectively.

$${\hat{w}}_{mls} = \frac{{w}_{mls}}{{w}_{mls} + {w}_{c}} and {\hat{w}}_{mls} = \frac{{w}_{k}}{{w}_{mls} + {w}_{c}}$$

The translation vector from the different transformations can be estimated as a weighted sum directly, giving a final transformation at a point of:

$$F ( x ) = x {Σ}_{x} + {\hat{w}}_{mls} {β}_{mls} + {\sum }_{k}^{K} {\hat{w}}_{k} {β}_{k} \qquad ( 19 )$$

As will be appreciated by the skilled person, matrix logarithms can be approximately calculated very rapidly using the Mercator series expansion when close to the identity matrix. The Eigen matrix logarithm may be used in other circumstances.

It will be appreciated that the disclosed methods provide a smooth nonlinear warping for any location that is not part of a constrained pixel set by smoothly blending the unconstrained and constrained transformations. The method also allows for the transformation of a set of constrained pixel locations to be linear. In other words, the same transformation is applied to any constrained pixel location. A selection of possible linear transformation parametrisations includes: fixed, translation, rigid, similarity, rigid+1 d stretch, affine etc, as would be understood by the skilled person. Alternatively, the transformation at the constrained pixel locations may be nonlinear, but have an alternative parameterisation to the unconstrained transformation, i.e. only allow translation/scaling in a single direction.

Pixel locations at the borders of the image may also be constrained, whereby they may follow a nonlinear transformation that prohibits them from moving inside the image, but they may slide along the border, or move outside the visible set of pixels.

The approaches described herein may be embodied on a computer-readable medium, which may be a non-transitory computer-readable medium. The computer-readable medium carrying computer-readable instructions arranged for execution upon a processor so as to make the processor carry out any or all of the methods described herein.

The term “computer-readable medium” as used herein refers to any medium that stores data and/or instructions for causing a processor to operate in a specific manner. Such storage medium may comprise non-volatile media and/or volatile media. Non-volatile media may include, for example, optical or magnetic disks. Volatile media may include dynamic memory. Exemplary forms of storage medium include, a floppy disk, a flexible disk, a hard disk, a solid state drive, a magnetic tape, or any other magnetic data storage medium, a CD-ROM, any other optical data storage medium, any physical medium with one or more patterns of holes, a RAM, a PROM, an EPROM, a FLASH-EPROM, NVRAM, and any other memory chip or cartridge.

It will be understood that the above description of specific embodiments is by way of example only and is not intended to limit the scope of the present disclosure. Many modifications of the described embodiments, some of which are now described, are envisaged and intended to be within the scope of the present disclosure.

The following sections form part of the disclosure and act to clarify some of the mathematical points discussed herein.

1. A method for manipulating an image using at least one image control handle, the image comprising pixels, wherein at least one set of constrained pixels defines a constrained region having a transformation constraint; the method comprising:
transforming pixels of the image based on an input received from the manipulation of the at least one image control handle;
wherein the transformation constraint applies to the pixels inside the constrained region, and the degree to which the transformation constraint applies to any respective pixel outside the constrained region is conditional on the distance between the respective pixel and the constrained region.

2. The method of claim 1, wherein the input comprises information relating to the displacement of the at least one image control handle from an original location in the image to a displaced location in the image.

3. The method of claim 2, wherein each pixel transformation is weighted by the distance from each respective pixel to an original location of the at least one image control handle such that pixels located nearer the original location of the image control handle are more influenced by the displacement of the at least one image control handle than those further away.

4. The method of claim 1, wherein the degree to which the transformation constraint applies to pixels outside the constrained region approaches zero for pixels at the original location of the at least one control handle.

5. The method of claim 2, wherein transforming each pixel based on the input comprises:
determining a first set of pixel transformations for the pixels outside the constrained region, each pixel transformation of the first set of pixel transformations being based on the displacement of the at least one image control handle; and
determining a second set of pixel transformations for pixels inside the constrained region, each pixel transformation of the second set of pixel transformations based on the displacement of the at least one image control handle and the transformation constraint.

6. The method of claim 5, further comprising:
applying the second set of transformations to the pixels inside the constrained region; and
applying a respective blended transformation to pixels outside the constrained region, wherein the blended transformation for a particular pixel outside the constrained region is a blend between the first and second transformation, and the degree to which the pixel follows the first transformation and/or the second transformation is determined by the distance between the respective pixel and the constrained region.

7. The method of claim 5, wherein the first and second sets of transformations are determined by minimising a moving least squares function.

8. The method of claim 1 wherein the image further comprises a plurality of constrained regions, each constrained region defined by a respective set of constrained pixels, and each constrained region having a respective transformation constraint associated therewith,
wherein the degree to which a particular transformation constraint applies to each pixel outside the constrained regions is based on the distance between a respective pixel and the constrained region associated with the particular transformation constraint.

9. The method of claim 8, wherein the constrained regions are not spatially contiguous.

10. The method of claim 8, wherein each constrained region is associated with a different transformation constraint.

11. The method of claim 1, wherein the distance between the respective pixel and the constrained region is a distance between the pixel and a border of the constrained region.

12. The method of claim 1, wherein the at least one image control handle is a plurality of image control handles and the input comprises information about the displacement of each of the plurality of image control handles; and the method comprises:
transforming each pixel based on the displacement of each of the plurality of image control handles.

13. The method of claim 2, wherein the degree to which the transformation of a particular pixel is influenced by the displacement of a particular image control handle is based on a weighting factor, the weighting factor being based on the distance from the particular pixel to an original location of the particular image control handle.

14. The method of claim 12, wherein the plurality of image control handles comprises a number of displaceable image control handles and a number of virtual image control handles which are not displaceable, the virtual image control handles being located around a border of the constrained region, and wherein the virtual image control handles are for lessening the influence of the displaceable image control points on the transformation of the constrained pixels;
wherein the method further comprises:
weighting the transformation of each respective pixel outside the constrained region based on the distance from each respective pixel outside the constrained area to each respective displaceable image control handle; and
weighting the transformation of each respective constrained pixel inside the constrained region based on distances from each respective constrained pixel to each of the plurality of image control handles, including the displaceable image control handles and the virtual image control handles.

15. The method of claim 1, wherein the at least one image control handle is selected from the group consisting of a point inside the image domain, a point outside the image domain, and a line in the image.

16. The method of claim 1, wherein the constrained region and/or the transformation constraint is selected by a user.

17. The method of claim 1, wherein the transformation constraint is selected from the group consisting of:
a constraint that the pixels within the constrained region must move coherently under a translation transformation;
a constraint that the pixels within the constrained region must move coherently under a rotation transformation;
a constraint that the pixels within the constrained region must move coherently under a stretch and/or skew transformation;
a constraint that the relative locations of the pixels within the constrained region must be fixed with respect to one another,
and combinations thereof.

18. The method of claim 1, wherein the transformation constraint comprises a directional constraint such that the pixels in the constrained region may only be translated, or stretched, positively or negatively, along a particular direction.

19. The method of claim 1, wherein those pixels located around the a border of the image are additionally constrained such that they only be translated, or stretched, along the border of the image or transformed outside the image domain.

20. The method of claim 1, wherein the degree to which the transformation constraint applies to any respective pixel outside of the constrained region can be modified through a predetermined factor.

21. The method of claim 1, wherein the degree to which the transformation constraint applies to any respective pixel outside the constrained region is conditional on the relative distances between the respective pixel and the constrained region, and between the respective pixel and the original location of the at least one image control handle.

22. The method of claim 1, wherein the transformation of the pixels in the constrained region takes the form of a predetermined type of transformation.

23. The method of claim 22, wherein the type of transformation is selected from the group consisting of a stretch, a rotation, a translation, an affine transformation, a similarity transformation, and combinations thereof.

24. The method of claim 1, further comprising:
determining, for each pixel in the constrained region, a constrained region pixel transformation based on the manipulation of the at least one control handle and the transformation constraint, and
determining, for each pixel outside the constrained region, both a constrained transformation and an unconstrained transformation, the constrained transformation being based on the manipulation of the at least one control handle and the transformation constraint, and the unconstrained transformation being based on the manipulation of the at least one image control handle.

25. The method of claim 24, wherein the unconstrained transformation for each pixel outside the constrained region is based on the manipulation of the at least one image control handle and is not based on the transformation constraint.

26. The method of claim 24, further comprising transforming the pixels in the constrained region based on the constrained region pixel transformations determined for the constrained pixels; and
transforming the pixels outside the constrained region based on a blended transformation, the blended transformation for a particular pixel outside the constrained region being based on the constrained transformation and the unconstrained transformation determined for the particular pixel, wherein the degree to which the blended transformation follows either the constrained or the unconstrained transformation at that particular pixel is determined by a blending factor based on the relative distances between the particular pixel and the original location of the at least one image control handle, and between the particular pixel and the constrained region.

27. A computer readable medium comprising computer-executable instructions which, when executed by a processor, cause the processor to perform the method of claim 1.
